(19) United States
(12) Patent Application Publication
(10) Pub. No.: US 2014/0378641 A1
(43) Pub. Date: Dec. 25, 2014

(54) COMPACT, LIGHTFAST POLYURETHANE MOULDED PARTS

(71) Applicant: Bayer Intellectual Property GmbH, Monheim (DE)

(72) Inventors: Birgit Meyer zu Berstenhorst, Leverkusen (DE); Reinhard Halpaap, Odenthal (DE); Norbert Eisen, Koln (DE); Uwe Pfeuffer, Leverkusen (DE); Gregor Murlowski, Koln (DE)

(21) Appl. No.: 14/372,043

(22) PCT Filed: Jan. 15, 2013
(86) PCT No.: PCT/EP2013/050639

§ 371 Date: Jul. 14, 2014

(30) Foreign Application Priority Data
Jan. 17, 2012 (DE) 10 2012 200 630.3

(51) Int. Cl. C08G 18/75; C08G 18/32; C08G 18/48; C08G 18/73; B29C 67/24; B29C 45/00

(52) U.S. Cl. CPC C08G 18/755; B29C 67/246; B29C 45/0001; C08G 18/4829; C08G 18/73; C08G 18/3206; C08G 18/3275; B29K 2075/00
USPC 528/77; 264/240

(57) ABSTRACT

The invention relates to compact, lightfast polyurethane moulded parts which consist of isocyanates, polyols and chain extenders and/or cross-linking agents, as well as to the use of same.

The invention relates to compact, lightfast polyurethane moldings made of isocyanates, of polyols, and of chain extenders and/or crosslinking agents, and also to use of these.

Polyurethanes (PURs) based on isocyanates having aromatically bonded NCO groups are known to be susceptible to discoloration on exposure to light. This is a problem in outdoor applications or in internal parts exposed to light. Production of lightfast moldings therefore requires a surface with appropriate properties.

Production of polyurethanes with high lightfastness usually uses aliphatically bonded isocyanates. EP-B 0379246 describes a use of these isocyanates to produce lightfast PUR. Lightfast outer skins are produced here, for example for the application on instrument panels. It is possible to manufacture compact and foamed aliphatic skins.

Specifically in applications such as by way of example in automobile interiors or in applications which use polyurethane as decorative layer, there is often a need for compact systems that are not susceptible to damage and that are as “robust” as possible (systems that are not destroyed when exposed to various influences). The Shore A hardness of these should be at least 70, preferably at least 75. The production of polyurethanes of this type from polyol and polyisocyanate should moreover use polyisocyanates that are easy to process without occupational health problems.

Aliphatic isocyanates are known to be markedly less reactive than aromatic isocyanates, and the amount of energy that has to be introduced into the reaction is therefore markedly greater. Mold temperatures needed in order to initiate the reaction and to allow it to achieve thorough curing are therefore frequently from 70 to 90° C. The systems described hitherto, as disclosed by way of example in WO 2004/000905, EP-B 0379246, and EP-A 0929586, therefore use aliphatic polyisocyanates with a high proportion of monomeric diisocyanate, in order that a strongly exothermic reaction can provide adequate hardening with formation of a high proportion of urethane groups. Hardening of these systems is achievable only through specific catalysis.

The value attributed to safety in the production process is moreover constantly increasing. It is desirable here to minimize use of hazardous substances, and this involves both health-related and cost-related aspects because safety has to be ensured by using additional extraction systems, enclosures, etc. From the point of view of occupational health, therefore, low-monomer-content polyisocyanates are preferable to the monomeric diisocyanates. Monomeric aliphatic diisocyanates are very generally classified as toxic hazardous substances and have a considerable vapor pressure, and processing of monomeric diisocyanate can therefore lead to presence of same in the workplace atmosphere. For safety reasons, operations should therefore use low-monomer-content systems. However, a disadvantage of these polyisocyanates having, for example, uretdione structures, isocyanurate structures, allophanate structures, biuret structures, iminooxadiazinedione structures, and/or oxadiazinetrione structures, with reaction products comprising urethane groups and/or isocyanate groups, known as isocyanate prepolymers, is that they have markedly lower NCO content than the monomers, and therefore the amount of isocyanate component that has to be used during the reaction to give polyurethanes is markedly greater. For a given molding density, the polyurethane is thus diluted, i.e. fewer new polyurethane reactions take place than when monomers are used. Since the polyurethane reaction liberates heat which further accelerates the reaction, low-monomer-content systems are mostly markedly slower/less reactive than systems with a high proportion of monomers.

Compact, aliphatic polyurethanes are mostly produced by using 1-isocyanato-3,3,5-trimethyl-5-isocyanatomethylcyclohexane (isophorone diisocyanate, IPDI), which has a certain stiffness due to its cyclohexane ring (U.S. Pat. No. 4,772,639). The only way of avoiding use of IPDI as monomer is to use it in derivatized form, in the form of low-monomer-content polyisocyanate having by way of example uretdione structures, isocyanurate structures, and/or allophanate structures, and/or in the form of low-monomer-content isocyanate prepolymer. However, it is known that low-monomer-content IPDI polyisocyanates which retain relatively high NCO contents, e.g. IPDI trimer (isocyanurate) and IPDI dimer (uretdione) take the form of solid or high-viscosity liquid at room temperature, and that these products are therefore difficult to process without solvent. Compact PUR systems are usually processed by the RIM process (Reaction Injection Molding). For this, not only the isocyanate component but also the polyol component should always have a viscosity of at most 30 000 mPas, measured at 20° C., in order to permit good mixing and processing at low temperatures.

When the different forms of polyisocyanates are compared with one another, in particular the isocyanurate structures, and also iminooxadiazinedione structures, or oxadiazinetrione structures, and the uretdione structure, have a favorable effect on hardness due to the additional ring structure. In contrast to this, allophanate polyisocyanates and biuret polyisocyanates give polyurethanes that tend to be somewhat softer. The use of derivatives of linear 1,6-diisocyanatohexane (HDI) likewise has an adverse effect on hardness. However, polyisocyanate compounds of HDI are, by virtue of their chemical structure, markedly less viscous than those of IPDI.

It is therefore not surprising that compact, hard polyurethanes are mostly produced with use of an IDPI isocyanurate/IPDI monomer mixture in a ratio by weight of about 30:70 (EP-A 0929586 or WO 2007/078725). However, these systems in particular have the disadvantage of the vapor pressure of the monomeric IPDI present, and of the resultant cost of avoiding occupational health problems during processing.

In order to eliminate this disadvantage, the person skilled in the art would resort to the known low-monomer-content, aliphatic polyisocyanates. However, for the abovementioned reasons (dependency of reactivity, processability, and also necessary achievable hardness) neither pure HDI polyisocyanates nor pure IPDI polyisocyanates are suitable. Low-monomer-content solvent-free blends of derivatives of linear aliphatic diisocyanates, e.g. HDI, and of derivatives of cycloaliphatic diisocyanates, e.g. IPDI, are already known for particular, selected applications.

EP-A 0693512 discloses low-monomer-content mixtures of cycloaliphatic polyisocyanates which are per se solid or have very high viscosity (>100 000 mPas/23° C.) with low-viscosity linear aliphatic polyisocyanates. They are used in combination with solvent-free polyols to produce abrasion-resistant coatings, in particular for sealing of balconies and of roofs.

Solvent-free polyisocyanate mixtures of HDI polyisocyanates and of polyisocyanates derived from cycloaliphatic diisocyanates are also known from EP-A 1484350. The application here is lightfast coating of decorative parts via combination with specific solvent-free polyester polyols having OH functionality <3.

In WO 2010/083958, too, mixtures of polyisocyanates produced from HDI and produced from cycloaliphatic diisocyanates are used for the production of lightfast compact or foamed polyurethanes, in particular for the production of casting resins.

It was therefore an object of the present invention to provide compact, lightfast polyurethanes/polyurethane moldings with use of an isocyanate component and of a polyol component, e.g. for the application sector of dashboards, door cladding, armrests, and consoles in automobile construction which have Shore A hardness of at least 70, preferably of at least 75, where the viscosity of the isocyanate component is to be at most 30 000 mPas (measured at 20° C.), and also a process for production of these, where polyisocyanates are used that, in respect of occupational health, can be processed in such a way that no volatile constituents pass into the surrounding atmosphere during processing and hardening.

This object was achieved by providing the polyurethanes and, respectively, polyurethane ureas described in more detail hereinafter, and the moldings produced therefrom. Surprisingly, appropriate moldings could be obtained from low-monomer-content (<0.5% by weight monomer content) aliphatic polyisocyanates having an average NCO functionality of from 2.0 to 3.2 and from short- and long-chain materials that are reactive toward isocyanates.

The present invention provides compact, lightfast polyurethane molding with Shore A hardness (measured in accordance with DIN 53505 at 23° C.) of at least 70, particular preferably with Shore A hardness (measured in accordance with DIN 53505 at 23° C.) of from 75 to 85, obtainable from
A) organic isocyanate compounds having at least two aliphatically bonded isocyanate groups,
B) polyols having an average molar mass of from 1000 to 15 000 g/mol and an average functionality of from 1.8 to 8 (number of OH groups per molecule), preferably from 2 to 6,
C) polyols and/or polyamines having a molar mass of from 60 to 500 g/mol and having a functionality (number of OH and/or NH groups of the polyols or of the polyamines per molecule) of from 2 to 8, preferably from 2 to 4, as chain extenders/crosslinking agents,
D) catalysts,
E) optionally other auxiliaries and additives,
   characterized in that component A) has less than 0.5% by weight, preferably less than 0.4% by weight, content of monomeric diisocyanate, a viscosity of at most 30 000 mPas (at 20° C.) (measured in accordance with DIN EN ISO 3219), preferably of at most 25 000 mPas (at 20° C.), particularly preferably of at most 20 000 mPas (at 20° C.), and an average NCO functionality of from 2.0 to 3.2, preferably from 2.2 to 3.0, very particularly preferably from 2.2 to <2.5.

The invention is based on the surprising observation that lightfast polyurethans with Shore A hardness values of at least 70 can be produced by combining solvent free mixtures that are known per se of low-monomer-content low-viscosity polyisocyanates A), in particular produced from linear aliphatic diisocyanates and from cycloaliphatic diisocyanates with polyols B), and with polyols and/or polyamines C).

Particular preference is moreover given to compact, lightfast polyurethane moldings obtainable from mixtures of from 35 to 95% by weight of at least one polyisocyanate a-1) produced from at least one linear aliphatic diisocyanate and having an NCO content of from 10 to 28% by weight and of from 5 to 65% by weight of at least one polyisocyanate a-2) produced from at least one cycloaliphatic diisocyanate and having an NCO content of from 10 to 22% by weight as organic isocyanate compounds A), where in the polyisocyanate mixture A) at least one of the polyisocyanates a-1) and a-2) has an average NCO functionality of ≦2.6, preferably ≦2.5, particularly preferably ≦2.4, and is present in an amount of at least 30% by weight, based on A).

Polyisocyanate component a-1) used preferably comprises aliphatic polyisocyanates which are low-monomer-content derivatives of monomeric linear aliphatic diisocyanates i-1). Suitable starting diisocyanates i-1) for these derivatives a-1) are any desired diisocyanates that are obtainable by phosgenation or by phosgene-free processes, for example by thermal urethane cleavage, that are within the molecular weight range from 140 to 400, and that have linear-aliphatic-bonded isocyanate groups. Examples of suitable compounds i-1) are 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, and any desired mixtures of these diisocyanates. The derivatives a-1) produced from the monomeric aliphatic diisocyanates i-1) are produced by conventional known processes, have concentrations below 0.5% by weight of monomeric diisocyanate i-1), and comprise by way of example uretdione structures, isocyanurate structures, allophanate structures, biuret structures, iminooxadiazinedione structures, oxadiazinetrione structures, and/or carbodiimide structures, of the type by way of example described in J. Prakt. Chem. 336 (1994) 185-200, in DE-A 1 670 666, and in EP-A 0 798 299. Polyisocyanates a-1) used can also comprise reaction products comprising urethane groups, and/or optionally allophanate groups, and also isocyanate groups, known as isocyanate prepolymers. The polyisocyanates a-1) preferably have from 10 to 28% by weight isocyanate content. Preferred, but not exclusive, isocyanate components a-1) are low-viscosity products based on HDI with <0.5% by weight monomer content. Particular preference is given to use of HDI polyisocyanates which comprise uretdione groups, and/or to use of HDI prepolymers.

Polyisocyanate component a-2) used preferably comprises cycloaliphatic polyisocyanates which are low-monomer-content derivatives of monomeric aliphatic diisocyanates i-2). Suitable starting diisocyanates i-2) for these derivatives a-2) are any desired diisocyanates that are obtainable by phosgenation or by phosgene-free processes, for example by thermal urethane cleavage, that are within the molecular weight range from 166 to 400, and that have cycloaliphatic-bonded isocyanate groups, or having isocyanatomethylcycloalkyl structures. Examples of suitable compounds i-2) are 1,3- and 1,4-diisocyanatocyclohexane, 1,3- and 1,4-bis(isocyanatomethyl)cyclohexane (H₆-XDI), 1-isocyanato-3,3,5-trimethyl-5-isocyanatomethylcyclohexane (isophorone diisocyanate, IPDI), 4,4′-diisocyanatodicyclohexylmethane (H₁₂-MDI, optionally in a mixture with the 2,4′-isomer), 1-isocyanato-1-methyl-4(3)isocyanatomethylcyclohexane (IMCI), bis(isocyanatomethyl)norbornane (NBDI) and any desired mixtures of these diisocyanates. The derivatives a-2) produced from the monomeric aliphatic diisocyanates i-2) are produced by conventional known processes, have concentrations below 0.5% by weight of monomeric diisocyanate i-2), and comprise by way of example uretdione structures, isocyanurate structures, allophanate structures, and/or carbodiimide structures. Polyisocyanates a-2) used can also comprise reaction products comprising urethane groups and/or optionally allophanate groups, and isocyanate groups, known as isocyanate prepolymers. The polyisocyanates a-2) preferably have from 10 to 22% by weight isocyanate content. Preferred, but not exclusive, isocyanate components a-2) are those based on IPDI or H₁₂-MDI having <0.5% by weight monomer content. Particular preference is given to use of IPDI polyisocyanates which comprise allophanate groups and/or isocyanurate groups.

Component B) has an average hydroxy functionality of from 1.8 to 8, preferably from 2 to 6, and is preferably composed of at least one polyhydroxy polyether with an average molar mass of from 1000 to 15 000 g/mol, with preference from 2000 to 13 000 g/mol, and/or of at least oligocarbonate polyol with an average molar mass of from 1000 to 5000 g/mol.

Suitable polyhydroxy polyethers are the alkoxylation products that are known per se from polyurethane chemistry, preferably derived from di- or trifunctional starter molecules or from mixtures of such starter molecules. Examples of suitable starter molecules are water, ethylene glycol, diethylene glycol, propylene glycol, trimethylolpropane (TMP), glycerol, and sorbitol. Particular alkylene oxides used for the alkoxylation are propylene oxide (PO) and ethylene oxide (EO), and these alkylene oxides can be used in any desired sequence and/or in the form of mixture. It is moreover possible to use, as component B), aliphatic oligocarbonate polyols, preferably oligocarbonate diols with an average molar mass of from 1000 to 5000 g/mol, preferably from 1000 to 2000 g/mol. Suitable aliphatic oligocarbonate polyols are the transesterification products that are known per se that derive from monomeric dialkyl carbonates, e.g. dimethyl carbonate, diethyl carbonate etc. with polyols or mixtures of polyols with OH functionality ≧2.0, e.g. 1,4-butanediol, 1,3-butanediol, 1,5-pentanediol, 1,6-hexanediol, 3-methyl-1,5-pentanediol, 1,12-dodecanediol, cyclohexanedimethanol, trimethylolpropane, and/or mixtures of said polyols with lactones, as described by way of example in EP-A 1 404 740 and EP-A 1 518 879. It is also possible to use polyether carbonate polyols of the type obtainable by way of example by catalytic reaction of alkylene oxides (epoxides) and carbon dioxide in the presence of H-functional starter substances (see, for example, EP-A 2046861). These polyether carbonate polyols generally have a functionality of at least 1, preferably from 2 to 8, particularly preferably from 2 to 6, and very particularly preferably from 2 to 4. The molar mass is preferably from 400 to 10 000 g/mol and particularly preferably from 500 to 6000 g/mol.

Component C) is preferably difunctional chain extenders with a molar mass of from 60 to 500 g/mol, preferably from 60 to 400 g/mol. Among the preferred chain extenders C) are dihydric alcohols, such as ethylene glycol, diethylene glycol, 1,4-butanediol, 1,6-hexanediol, and mixtures of such diols. Equally suitable as component C) or as part of component C) are diols that have ether groups and have molar masses of less than 500 g/mol, preferably less than 400 g/mol, of the type obtainable by propoxylation and/or ethoxylation of dihydric starter molecules of the type mentioned by way of example above. Equally suitable chain extenders C) are diamines, such as ethylenediamine or preferably those having amino groups on arylalkyl moieties, an example being 1,3-xylylenediamine. Aminoalcohols such as ethanolamine, diethanolamine, or triethanolamine are moreover suitable as component C). It is moreover possible to use polycarbonatediols as long as their molar mass is below 500 g/mol. It is equally possible to use any desired mixtures of the chain extenders mentioned by way of example. The amounts used of the chain extenders C) are preferably from 2 to 15% by weight, with preference from 4 to 12% by weight, based on the weight of the entirety of components B), C), D), and E).

Catalysts D) used can be the familiar catalysts known for polyurethane, these being listed by way of example in WO 2008/034884 or EP-A 0929586. Among these are not only salts and chelates of tin, zinc, bismuth, iron, mercury but also tertiary amine compounds. It is preferable to use organotin compounds, such as dimethyltin(IV) didodecylmercaptide, dimethyltin(IV) bis(2-ethylhexyl thioglycolate), dimethyltin(IV) dimethylene isooctyl ester mercaptide, dimethyltin(IV) didecylmercaptide, dimethyltin(IV) butenyldicarboxylate, dimethyltin(IV) dilaurate and dimethyltin(IV) di(neodecyl carboxylate). It is preferable to use nonfungitive catalysts.

Auxiliaries and additives E) that can optionally be used concomitantly are compounds of the type known per se. These are the compounds that are conventional and known for the production of polyurethanes, e.g. stabilizers, pigments, fillers, or else water, which is optionally used concomitantly in an amount of up to 0.3% by weight, based on the weight of component B). However, it is preferable that the PURs are produced without addition of water.

Stabilizers are not only UV absorbers, antioxidants, and free-radical scavengers but also foam stabilizers. UV absorbers can be not only inorganic compounds, such as titanium dioxide, zinc oxide, or cerium dioxide, but also organic compounds, such as 2-hydroxybenzophenones, 2-(2-hydroxyphenyl)benzotriazoles, 2-(2-hydroxyphenyl)-1,3,5-triazines, 2-cyanacrylates, and oxalanilides. Among the free-radical scavengers are, as is known, HALS systems (Hindered Amine Light Stabilizer), and antioxidats used can be sterically hindered phenols and/or secondary aromatic amines. Foam stabilizers are mostly composed of polyethersiloxanes or of block copolymers of polyoxyalkylenes.

Examples of pigments and fillers are calcium carbonate, graphite, carbon black, titanium dioxide, iron oxide, wollastonite, glass fibers, carbon fibers, and/or else organic dyes and, respectively, fillers.

Other examples of component E) “auxiliaries and additives” are listed in “Kunststoffhandbuch 7—Polyurethanes” [Plastics handbook 7—Polyurethanes], Becker/Braun, Carl Hanser Verlag, Munich/Vienna, 1993, 104ff.

The amounts of the starting components are moreover such as to provide compliance with an isocyanate index of from 80 to 120, preferably from 95 to 105. The isocyanate index is the quotient calculated from the number of NCO groups divided by the number of groups reactive toward NCO, multiplied by 100.

The PURs are generally produced by combining components B) to E) to give a “polyol component”, these then being mixed with the polyisocyanate component A) and reacted in closed molds. Conventional devices are used here for measurement and metering.

The moldings of the invention are used by way of example as stearing wheels or door side cladding, or else protective coverings for instrument panels, or generally in the form of decorative panels in automobile interiors. The moldings of the invention are suitable as cladding for dashboards and consoles, and cladding of doors or of parcel shelves in the vehicle sector. Other application sectors can be: materials surrounding automobile windows, materials surrounding other windows, materials surrounding solar modules, materials surrounding worktop edges, materials surrounding metal supports and, respectively, metal inserts for, by way of example, windshots and cables. The moldings can be produced by RIM processes or else by direct application to other supports made of, by way of example, polycarbonate, of polycarbonate blends, of aromatic polyurethanes, or of other injection-molding plastics, in the directskinning process.

The temperature of the reaction components (polyisocyanate component A) and, respectively, “polyol component” composed of components B), C), D), and E)) during production of the polyurethanes is generally within the temperature range from 20 to 60° C. The temperature of the molds is generally from 20 to 100° C., preferably from 50 to 90° C.

The amount of the reactive mixture of components A) to E) introduced into the mold is judged in such a way that resultant envelope densities of the moldings are from 750 to 1200 kg/m³, preferably from 900 to 1150 kg/m³.

The examples below will provide further explanation of the invention.

### EXAMPLES

All percentages (compositions) relate to weight unless otherwise stated.

NCO contents, stated in % by weight, were determined titrimetrically in accordance with DIN EN ISO 11909.

NCO functionalities were calculated from GPC measurement (gel permeation chromatogram) and NCO content.

OH numbers were determined titrimetrically by a method based on DIN 53240 T.2.

Residual monomer contents were measured in accordance with DIN EN ISO 10283 by gas chromatography with internal standard.

Unless otherwise stated, viscosity measurements were made with a Physica MCR 51 Rheometer from Anton Paar Germany GmbH (DE) in accordance with DIN EN ISO 3219 (1994). Measurements at different shear rates ensured that the rheology of the polyisocyanate mixtures described corresponded to that of ideal Newtonian liquids. A difference from the standard is that the shear rate is not therefore stated.

Shore hardness values were measured in accordance with DIN 53505 at 23° C. with the aid of a Zwick 3100 Shore hardness tester (Zwick, Del.).

The tensile test was carried out on a Z020 from Zwick in accordance with DIN 53504/ISO 37.

Tear strength was likewise measured on a Z020 from Zwick in accordance with DIN ISO 34.

Polyisocyanates a-1)

Polyisocyanate A1):

HDI polyisocyanate comprising isocyanurate groups and uretdione groups was produced by tributylphosphine-catalyzed oligomerization of HDI by a method based on example la) of EP-A 0 377 177 but without concomitant use of 2,2,4-trimethyl-1,3-pentanediol. The reaction was terminated when the NCO content of the crude solution was 42%, and unreacted HDI was removed by thin-layer distillation at a temperature of 130° C. and a pressure of 0.2 mbar.
NCO content: 22.7%
NCO functionality: 2.2
Monomeric HDI: 0.3%
Viscosity (23° C.): 90 mPas

Polyisocyanate A2):

HDI polyisocyanate comprising isocyanurate groups and uretdione groups was produced by tributylphosphine-catalyzed oligomerization of HDI by a method based on example 2) of EP-A 0 377 177. Removal of the excess monomeric HDI by thin-layer distillation gave a polyisocyanate with the following properties:
NCO content: 22.5%
NCO functionality: 2.5
Monomeric HDI: 0.3%
Viscosity (23° C.): 170 mPas

Polyisocyanate A3):

An HDI polyisocyanate A3) having isocyanurate groups was produced in accordance with EP-A 0330966, example 11, using 2-ethylhexanol instead of 2-ethyl-1,3-hexanediol as catalyst solvent. Removal of the excess monomeric HDI by thin-layer distillation gave an HDI polyisocyanate with the following properties:
NCO content: 22.9%
NCO functionality: 3.1
Monomeric HDI: 0.1%
Viscosity (23° C.): 1200 mPas

Polyisocyanate A4):

7 mol of 1,6-diisocyanatohexane (HDI) and 1 mol of a polypropylene oxide diol with an average molecular weight of 400 (OH number=280) were reacted at 80° C. until constant NCO content was reached. The excess of monomeric HDI was then removed by thin-layer distillation at a temperature of 130° C. and a pressure of about 0.5 mbar.
NCO content: 12.6%
NCO functionality: 2.0
Monomeric HDI: 0.2%
Viscosity (23° C.): 4250 mPas

Polyisocyanates a-2)

Polyisocyanate A5):

4000 g of IPDI were degassed at 40° C. in vacuo and, under N₂, 25 g of 5% by weight solution of trimethylbenzylammonium hydroxide in n-butanol/methanol (9:1) were admixed in portions, and the mixture was reacted at 70° C. until 30% NCO content was reached. The reaction was terminated by adding 5 g of 25% by weight solution of dibutyl phosphate in IPDI, and stirring was continued for 1 h at 60° C. Monomeric IPDI was then removed by distillation by means of a thin-layer evaporator at from 180 to 190° C. and 0.2 mbar, giving 1600 g of a solid (at room temperature) resin with the following properties:
NCO content: 16.7%
NCO functionality: 3.3
Monomeric IPDI: 0.35%
Viscosity (140° C.): 17 000 mPas

Polyisocyanate A6):

10 mol (2222 g) of isophorone diisocyanate (IPDI) were reacted with a mixture of 0.55 mol (40.7 g) of n-butanol and 0.45 mol (39.6 g) of 1-pentanol at 100° C. until the calculated NCO content of 34.7% was reached. For the subsequent trimerization/allophanatization, a 5% solution (about 5 g) of trimethylbenzylammonium hydroxide dissolved in 2-ethylhexanol as catalyst was added dropwise at 95° C. in such a way that the NCO content of the solution had reached from 28.5 to 29% after about 1.5 h. The reaction was terminated by adding a 25% solution of dibutyl phosphate (about 0.6 g) dissolved in IPDI. Stirring was continued for 1 h at 120° C. The excess of monomeric IPDI was then removed by thin-layer distillation at a temperature of 150° C. and a pressure of about 0.5 mbar. This gave a solid (at room temperature) resin with the following properties:
NCO content: 15.0%
NCO functionality: 2.4
Monomeric IPDI: 0.4%
Viscosity (100° C.): 17 000 mPas

Polyisocyanate A7):

Isophorone diisocyanate (IPDI) was trimerized as in example 2 of EP-A0003765 until NCO content was 31.1%. This gave a mixture of IPDI trimer/IPDI monomer with the following properties:
NCO content: 31.1%
NCO functionality: 2.2
Viscosity (23° C.): 240 mPas

Polyisocyanate I:

Low-viscosity IPDI trimer/IPDI monomer mixture polyisocyanate A7). Viscosity at 20° C. in accordance with DIN 53019 about 350 mPas, NCO functionality about 2.2

Polyisocyanate II:

Mixture of 50 parts by weight of polyisocyanate A4) and 50 parts by weight of polyisocyanate A1). Viscosity at 20° C. in accordance with DIN 53019 about 420 mPas, NCO functionality about 2.1

Polyisocyanate III:

Mixture of 60 parts by weight of polyisocyanate A6) and 40 parts by weight of polyisocyanate A1). Viscosity at 20° C. in accordance with DIN 53019 about 24 480 mPas, NCO functionality about 2.3

Polyisocyanate IV:

Mixture of 15 parts by weight of polyisocyanate A5), 35 parts by weight of polyisocyanate A3), and 50 parts by weight of polyisocyanate A4). Viscosity at 20° C. in accordance with DIN 53019 about 10 200 mPas, NCO content 16.8%, NCO functionality about 2.7.

Polyisocyanate V:

Mixture of 31.5 parts by weight of polyisocyanate A5), 33.5 parts by weight of polyisocyanate A2), and 35 parts by weight of polyisocyanate A3). Viscosity at 20° C. in accordance with DIN 53019 about 11 610 mPas, NCO content 20.8%, NCO functionality about 2.9.

Polyol:

Polyether polyol with OH number 28; produced by alkoxylation of sorbitol with propylene oxide/ethylene oxide (PO/EO) in a ratio by weight of 82:18, and having mainly primary terminal OH groups.

Table 1 below describes the components and amount used of these for the production of the polyurethane.

TABLE 1
Compositions

| | Example | | | | | |
|---|---|---|---|---|---|---|
| | 1 | 2 | 3* | 4* | 5* | Component |
| Polyol | 86.0 | 86.0 | 86.0 | 86.0 | 86.0 | B |
| Isophoronediamine | 1.50 | 1.50 | 1.50 | 1.50 | 1.50 | C |
| (chain extender) | | | | | | |
| Fomrez UL22 | 0.1 | 0.1 | 0.1 | 0.1 | 0.1 | D |
| (catalyst); | | | | | | |
| from Momentive | | | | | | |
| Performance Materials | | | | | | |
| Fomrez UL28 | 0.3 | 0.3 | 0.3 | 0.3 | 0.3 | D |
| (catalyst); | | | | | | |
| from Momentive | | | | | | |
| Performance Materials | | | | | | |
| 1,4-Butanediol | 7.4 | 7.4 | 7.4 | 7.4 | 7.4 | C |
| Diethanolamine | 2.0 | 2.0 | 2.0 | 2.0 | 2.0 | C |
| Ethanolamine | 2.50 | 2.50 | 2.50 | 2.50 | 2.50 | C |
| Irganox 1076 | 1.50 | 1.50 | 1.50 | 1.50 | 1.50 | E |
| (antioxidant) | | | | | | |
| Isocyanate I | 47.8 | — | — | — | — | A |
| Isocyanate II | — | 82.9 | — | — | — | A |
| Isocyanate III | — | — | 81.5 | — | — | A |
| Isocyanate IV | — | — | — | 90.9 | — | A |
| Isocyanate V | — | — | — | — | 75.4 | A |

*of the invention

TABLE 2
Properties

| Example | 1 | 2 | 3* | 4* | 5* |
|---|---|---|---|---|---|
| Density of | 1017 | 1020 | 990 | 1120 | 1120 |
| molding | | | | | |
| [kg/m³] | | | | | |
| Type | Monomer- | Low | Low | Low | Low |
| | containing | monomer | monomer | monomer | monomer |
| | | content | content | content | content |
| Cream time | 20 | 18 | 21 | 16 | 15 |
| [s] | | | | | |
| Fiber time | 25 | 20 | 25 | 19 | 17 |
| [s] | | | | | |
| Shore A | 86 | 61 | 83 | 77 | 79 |
| Tear strength | 10 | — | 13 | 5 | 4 |
| [kN/m] | | | | | |
| Tensile | 5.2 | — | 4.7 | 8.7 | 3.4 |
| strength | | | | | |
| [N/mm²] | | | | | |

*of the invention

The mold temperature in the experiments was 70° C., and the mold size was 100×100×20 mm³.

The temperature of the components used was 25° C. both the isocyanate and for the polyol formulation.

The amount charged to the mold was judged in such a way as to give the stated envelope density.

Experiment 1 is a comparative experiment using a large amount of isocyanate monomer and only IPDI compounds. The polyisocyanate I used had very low viscosity, and it was possible to produce the molding within a very short time with Shore A 86. However, a considerable disadvantage was that in experiment 1 it was necessary to operate with large amounts of low-molecular-weight monomeric aliphatic diisocyanates, which are classified as substances that are toxic, sensitizing, and irritant in the workplace, and in some cases have a high vapor pressure. For reasons of occupational health, the processing of this mixture comprising monomeric diisocyanates incurred high cost for technical safety measures. An additional risk is that, in particular when an excess of polyisocyanate is used, monomeric diisocyanate not consumed in the reaction can remain in the component for a relatively long period and can gradually escape therefrom by evaporation.

In contrast, processing is markedly simpler when the polyisocyanates to be used in the invention are used (inventive examples 3, 4, and 5), and in comparative experiment 2, which also used low-monomer-content polyisocyanates. The polyisocyanates used have a low vapor pressure, and monomeric diisocyanate does not therefore pollute the surrounding air during processing. There is therefore almost no possibility that monomeric diisocyanate can escape by evaporation from the finished component. In terms of reactivity, these systems are similar to the system of comparative example1; the systems of comparative experiment 2 and of experiments 4 and 5 are actually somewhat more reactive. However, another observation is that the system based only on HDI in comparative experiment 2 has only very low Shore A hardness, and is therefore relatively soft. Pure HDI polyisocyanates therefore appear to have little suitability for compact, relatively hard polyurethane components based on aliphatic, low-monomer-content polyisocyanates.

Other observations are that use of the system in inventive example 3 moreover achieves better tear strength, and use of the system in inventive example 4 achieves better tensile strength than the system in comparative example 1.

1-11. (canceled)

12. A compact, lightfast polyurethane molding with Shore A hardness (measured in accordance with DIN 53505) of at least 70 obtained from
A) an organic isocyanate compound having at least two aliphatically bonded isocyanate groups,
B) a polyol having an average molar mass of from 1000 to 15 000 g/mol and an average functionality of from 1.8 to 8,
C) a polyol and/or polyamine having a molar mass of from 60 to 500 g/mol and having a functionality of from 2 to 8 as chain extenders/crosslinking agents,
D) a catalyst, and
E) optionally, other auxiliaries and additives,
wherein component A) has less than 0.5% by weight content of monomeric diisocyanate, a viscosity (measured in accordance with DIN EN ISO 3219) of at most 30 000 mPas (at 20° C.), and an average NCO functionality of from 2.0 to 3.2.

13. The compact, lightfast polyurethane molding as claimed in claim 12, wherein the polyol B) has an average functionality of from 2 to 6.

14. The compact, lightfast polyurethane molding as claimed in claim 12, wherein the polyol and/or polyamine C) as chain extenders/crosslinking agents has a functionality of from 2 to 4.

15. The compact, lightfast polyurethane molding as claimed in claim 12, wherein component A) has an average NCO functionality of from 2.2 to 3.0.

16. The compact, lightfast polyurethane molding as claimed in claim 12, wherein component A) has an average NCO functionality of from 2.2 to <2.5.

17. The compact, lightfast polyurethane molding as claimed in claim 12 with Shore A hardness (measured in accordance with DIN 53505) of from 75 to 85.

18. The compact, lightfast polyurethane molding as claimed in claim 12, wherein the organic isocyanate compounds A) are mixtures of from 35 to 95% by weight of at least one polyisocyanate a-1) produced from at least one linear aliphatic diisocyanate and having an NCO content of from 10 to 28% by weight and of from 5 to 65% by weight of at least one polyisocyanate a-2) produced from at least one cycloaliphatic diisocyanate and having an NCO content of from 10 to 22% by weight, and wherein in the polyisocyanate mixture at least one of the polyisocyanates a-1) and a-2) has an average NCO functionality of ≦2.6 and is present in an amount of at least 30% by weight, based on A).

19. The compact, lightfast polyurethane molding as claimed in claim 18, wherein in the polyisocyanate mixture A) at least one of the polyisocyanates a-1) and a-2) has an average functionality of ≦2.5.

20. The compact, lightfast polyurethane molding as claimed in claim 18, wherein in the polyisocyanate mixture A) at least one of the polyisocyanates a-1) and a-2) has an average functionality of ≦2.4.

21. A method comprising utilizing the molding as claimed in claim 12 as cladding for dashboards and consoles, as cladding of doors and parcel shelves in the vehicle sector, as materials surrounding automobile windows, materials surrounding other windows, materials surrounding solar modules, materials surrounding worktop edges, materials surrounding metal supports and metal inserts.

22. A process for the production of the molding as claimed in claim 12 by a RIM (Reaction Injection Molding) process or by direct application of the mixture of components A) to E) to a support made of a polycarbonate, of a polycarbonate blend, of an aromatic polyurethane, or of an injection-molding plastic in the direct skinning process.
